(19) United States
(12) Patent Application Publication
(10) Pub. No.: US 2017/0238587 A1
(43) Pub. Date: Aug. 24, 2017

(54) IMPROVED FOOD PRODUCTS FROM LEGUMES

(71) Applicant: Blue Ribbon Roasting Pty Ltd, Kenmore, Queensland (AU)

(72) Inventors: Ken Quail, Kenmore, Queensland (AU); Michele Cooper, Kenmore, Queensland (AU); Andrew Boundy, Kenmore, Queensland (AU)

(21) Appl. No.: 15/519,514

(22) PCT Filed: Oct. 16, 2015
(86) PCT No.: PCT/AU2015/050642

§ 371 Date: Apr. 14, 2017

(30) Foreign Application Priority Data
Oct. 16, 2014 (AU) 2014904139

(51) Int. Cl. A23L 11/00; A23L 2/02; A23L 33/105

(52) U.S. Cl. CPC A23L 11/00; A23L 33/105; A23L 2/02; A23V 2002/00

(57) ABSTRACT

A process is provided for the treatment of a particulate leguminous plant material, such that the processed particulate leguminous plant material possesses characteristics that are desirable for animal, such as human, consumption. The leguminous plant material is subjected to one or more cycles of temperature treatment, each cycle including a heating phase and a cooling phase. The heating phase temperature of at least one of the temperature treatment cycles may be lower than the heating phase temperature of the preceding temperature treatment cycle. Particulate leguminous plant material comprising substantially reduced concentrations of one or more molecules that contribute to odour and/or flavour may be produced by the process. Particulate leguminous material produced by the process may be used as a food, or as an ingredient in a food product.

### FIELD OF THE INVENTION

THIS invention relates to the use of processed legume-derived products for food. More particularly, the invention relates to processed leguminous plant material with desirable characteristics for use as a food, or as an ingredient in a food product, and the process of developing said material.

### BACKGROUND TO THE INVENTION

Both palatability and nutritional properties are key considerations for food products. For many individuals, food products that are highly palatable often have undesirable nutritional properties, while food products with desirable nutritional properties are often relatively unpalatable. This phenomenon has substantial implications for human health, with poor diet a major factor in morbidity globally.

Many legumes (family Fabaceae), particularly the ‘grain legumes’ or ‘pulse legumes’ (e.g. beans, broad beans, lentils, peas and lupins) are food and/or forage crops. Food crop legumes possess nutritional profiles that are generally considered to be highly desirable for human health. For example, pulse legumes are relatively high in fibre, protein, antioxidants, and many vitamins including folate, thiamine, and pantothenic acid; contain very low levels of saturated fat; and have an extremely low glycaemic index (GI). However, pulse legumes are also known for their ‘beany’ or ‘grassy’ odour and flavour; such odour and flavour is undesirable or even unacceptable with regard to the palatability of certain food products generally, or for certain food products in some markets and/or for some individuals.

Material derived from legumes that retains or enhances the beneficial nutritional qualities of legumes, but possesses odour and/or flavour that is ‘neutral’ or ‘mild’ is therefore highly desirable for use in a range of food products. It follows that a process for producing said material is also highly desirable.

### SUMMARY OF THE INVENTION

The present invention recognizes a need for producing a legume-based food product or ingredient having at least partial flavour neutrality. Such a legume-based food product or ingredient may be particularly useful in the food industry as a source of nutrients such as fibre or protein which is substantially flavour neutral.

The present invention therefore provides a process for the treatment of a particulate leguminous plant material, such that the processed particulate leguminous plant material possesses characteristics that are desirable for animal consumption, as compared to corresponding leguminous plant material that is unprocessed or processed using one or more other methods. Furthermore, the present invention provides the use of a particulate leguminous plant material produced using said process for animal consumption.

The present invention also provides a processed particulate leguminous plant material that possesses characteristics that are desirable for animal consumption, as compared to a corresponding leguminous plant material that is unprocessed or processed using one or more other methods. Furthermore, the present invention provides the use of said processed leguminous plant material for animal consumption.

In a first aspect the invention provides a process for the production of a particulate leguminous plant material suitable for animal consumption, including the step of subjecting a particulate leguminous plant material to one or more cycles of temperature treatment, each cycle including a heating phase and a cooling phase, to thereby produce a particulate leguminous plant material having one or more desired characteristics suitable for animal consumption.

In a second aspect, the invention provides a processed particulate leguminous plant material produced according to the process of the first aspect.

In a third aspect, the invention provides a processed particulate leguminous material that comprises substantially or significantly reduced amounts or concentrations of one or more molecules that normally contribute to odour and/or flavour, and/or comprises a relatively increased amount or concentration of one or more vitamins.

In a fourth aspect, the invention provides the use of a particulate leguminous plant material according to the second or third aspects as a food.

In a fifth aspect, the invention provides a food product comprising the particulate leguminous plant material according to the second or third aspects.

In a sixth aspect, the invention provides the use of a particulate leguminous plant material according to the second or third aspects, in the production of a food product.

Preferably, the leguminous plant material of the aforementioned aspects is a mung bean, a chickpea, or a faba bean.

Preferably, a processed leguminous plant material of the aforementioned aspects possesses a significantly or substantially reduced amount or concentration of one or more molecules that normally contribute to odour and/or flavour.

In some embodiments, the one or more molecules are, or include, alcohols, alkanals, alkenes, alkanones (e.g. C₆ and/or C₇ compounds), heterocyclic aromatics such as pyridines and furans, sulphides or other sulphur-containing compounds, although without limitation thereto. In particular embodiments, said one or more molecules are selected from the group consisting of hexanal, 3-hexen-1-ol, 1-hexanol, methyl pyridine, thiophene, 2-heptanone, 2-pentylfuran, dimethyltrisulphide, methyl propyl sulphide, 2-methyl butanal, 2,5-dimethyldisulphide and pyrazine.

Preferably, the processed leguminous plant material of the aforementioned aspects possesses a similar or higher amount or concentration of a vitamin compound as compared to a corresponding leguminous plant material that is unprocessed, or processed using one or more other methods. In particular embodiments, the vitamins are B group vitamins and/or Vitamin C. In particular embodiments, the vitamins are selected from the following group: pantothenic acid (Vitamin B5), ascorbate (Vitamin C), thiamin (Vitamin B1), riboflavin (Vitamin B2), niacin (Vitamin B3), pyridoxine (Vitamin B6), and folate (Vitamin B9).

Suitably, the processed leguminous plant material, or food product comprising same, is for human use as a food.

Throughout this specification unless the context requires otherwise, “animal consumption” will be understood to mean use by an animal as a food, and/or the incorporation into a product for animal use as a food.

In certain preferred embodiments said animal is a human.

Throughout this specification, unless the context requires otherwise, the words “comprise”, “comprises” and “comprising” will be understood to mean the inclusion of a stated integer or group of integers but not the exclusion of any other integer or group of integers.

### BRIEF DESCRIPTION OF THE FIGURES

In order that the invention may be readily understood and put into practical effect, preferred embodiments will now be described by way of example with reference to the accompanying figures, wherein:

FIG. 1 sets forth gas chromatography olfactometry (GC-0) data obtained from an unprocessed ground mung bean sample (Control) and ground mung bean samples treated using the process of the invention described herein: Treatment-1 (1 cycle); Treatment-2: (1 cycle); Treatment-3 (2 cycles) and Treatment-3-2 (3 cycles). Relative amounts (vertical axis) measured in parts-per-million (ppm) of key odour-active compounds (horizontal axis) in the headspace of the samples are shown.

FIG. 2 outlines gas chromatography mass spectrometry (GC-MS) total ion chromatogram (TIC) profiles for an unprocessed ground mung bean sample (Control; green trace) and a ground mung bean Treatment-2 sample (red trace) showing the abundance of volatiles. ‘IS’ is an internal standard.

FIG. 3 sets forth gas chromatography olfactometry (GC-0) data obtained from control samples of chickpea and faba bean, and samples of chickpea and faba bean processed according to the invention, for key odour-active compounds. C-01 is an unprocessed chickpea kibble sample. C-01 Ground is an unprocessed ground chickpea sample. C-02 is a processed ground chickpea sample (1 cycle of temperature treatment). C-03 is a processed ground chickpea sample (3 cycles of temperature treatment). F-01 is an unprocessed faba bean kibble sample. F-01-Ground is an unprocessed ground faba bean sample. F-02 is a processed ground faba bean sample (1 cycle of temperature treatment). F-03 is a processed ground faba bean sample (3 cycles of temperature treatment). Relative amounts (vertical axis), measured as area counts, of key odour-active compounds in the headspace of the samples are shown. Hexanal data is presented in a first graph at the top of FIG. 3. For all other compounds, coloured bars are used, with the key for compound to bar colour inset.

FIG. 4 sets forth gas chromatography olfactometry (GC-0) data obtained from control samples of chickpea and faba bean, and samples of chickpea and faba bean processed according to the invention, for key odour-active compounds. C-01 is an unprocessed chickpea kibble sample. C-01 Ground is an unprocessed ground chickpea sample. C-02 is a processed ground chickpea sample (1 cycle of temperature treatment). C-03 is a processed ground chickpea sample (3 cycles of temperature treatment). F-01 is an unprocessed faba bean kibble sample. F-01-Ground is an unprocessed ground faba bean sample. F-02 is a processed ground faba bean sample (1 cycle of temperature treatment). F-03 is a processed ground faba bean sample (3 cycles of temperature treatment). Relative amounts (vertical axis), measured as area counts, of key odour-active compounds in the headspace of the samples are shown. Coloured bars are used, with the key for compound to bar colour inset.

### DETAILED DESCRIPTION OF THE INVENTION

The present invention arises, at least in part, from the observation that subjecting a particulate leguminous plant material to a process involving cycles of temperature treatment, each cycle including a heating phase and a cooling phase, confers upon a particulate leguminous plant material characteristics that may make it more desirable for animal consumption.

Said animal may include a fish, an avian animal (e.g. poultry); a mammal such as a human, livestock (e.g. cattle and sheep), a domestic pet (e.g. cats and dogs), a performance animal (e.g. racehorses), and a laboratory animal (e.g. rats, mice and rabbits), although without limitation thereto.

Preferably, said animal is a human.

The result of the process described by this invention may be the production of a particulate leguminous plant material with ‘neutral’ or ‘mild’ odour and/or flavour, but similar or higher levels of beneficial substances for animal consumption, as compared to a corresponding leguminous plant material that is unprocessed, or processed using one or more other methods.

Therefore, the process of the present invention overcomes some existing disadvantages of the use of leguminous plant products for animal consumption. The present invention also overcomes disadvantages and limitations of particulate leguminous plant material produced using existing processing methods. Disadvantages of processed leguminous plant material produced using other such methods may include, but are not limited to, undesirable odour and/or flavour for animal consumption, and/or the loss of substances that are beneficial for animal consumption.

It will be appreciated by those skilled in the art that “legume” refers to any species of plant of the family ‘Fabaceae’ and “leguminous” means of or relating to legumes. It will also be appreciated that “plant material” may refer to any part of a plant including, but not limited to, the roots, the shoots, the stem, the leaves, the flowers, the fruit, and the seeds. It will be further appreciated that “bean” may refer to a particular form of seed produced by some legumes that is often ‘large’ and ‘fleshy’, relative to, for example, a cereal grain.

Throughout this specification, unless the context requires otherwise, the words “cool”, “cooling”, or “cooled” will be understood to mean reducing or lowering a temperature from a previous temperature. Similarly, the words “heat”, “heating”, or “heated” will be understood to mean increasing or raising a temperature from a previous temperature. Furthermore, “cooling phase” will be understood to mean a period of time during which a temperature is reduced or lowered from a previous temperature, and “heating phase” will be understood to mean a period of time during which a temperature is increased or raised from a previous temperature. Additionally, throughout this specification, “heating phase temperature” will be understood to mean a temperature that is applied during a heating phase, and “cooling phase temperature” will be understood to mean a temperature that is applied during a cooling phase.

In a general aspect, this invention provides a process for the production of a particulate leguminous plant material suitable for animal consumption, including the step of subjecting a particulate leguminous plant material to one or more cycles of temperature treatment, each cycle including a heating phase and a cooling phase, to thereby produce a particulate leguminous plant material having one or more desired characteristics suitable for animal consumption.

Suitably, the heating phase temperature and the duration of the heating phase is sufficient to achieve a “maximum product temperature”. Throughout this specification, “maximum product temperature” will be understood to mean a maximum or highest temperature of a particulate leguminous plant material that occurs during a heating phase.

Suitably, the cooling phase temperature and the duration of the cooling phase is sufficient to achieve a “minimum product temperature”. Throughout this specification, “minimum product temperature” will be understood to mean a minimum or lowest temperature of a particulate leguminous plant material that occurs during a cooling phase.

In certain embodiments of the process described by this invention, the number of cycles of temperature treatment may be at least two, at least three, at least four, at least five, at least six, at least seven, or at least eight.

Preferably, the number of cycles of temperature treatment is at least three.

In preferred embodiments, the heating phase temperature during each of the one or more cycles is between about 120° C. and about 190° C.; including about 125° C., about 130° C., about 135° C., about 140° C., about 145° C., about 150° C., about 155° C., about 160° C., about 165° C., about 170° C., about 175° C., and about 185° C.

In said preferred embodiments, preferably, the maximum product temperature during the heating phase of each of the one or more cycles is between about 120° C. and about 190° C.; including about 125° C., about 130° C., about 135° C., about 140° C., about 145° C., about 150° C., about 155° C., about 160° C., about 165° C., about 170° C., about 175° C., about 180° C., and about 185° C.

In other preferred embodiments, the heating phase temperature during each of the one or more cycles is between about 140° C. and about 180° C.; including about 145° C., about 150° C., about 155° C., about 160° C., about 165° C., about 170° C., about 175° C., and about 180° C.

In said other preferred embodiments, preferably, the maximum product temperature during the heating phase of each of the one or more cycles is between about 140° C. and about 180° C.; including about 145° C., about 150° C., about 155° C., about 160° C., about 165° C., about 170° C., about 175° C., and about 180° C.

In certain embodiments, the heating phase temperature is approximately the same for each of the one or more cycles.

In said embodiments, preferably, the maximum product temperature is approximately the same during each of the one or more cycles.

In certain other embodiments, the heating phase temperature of at least one of the one or more cycles is higher than the heating phase temperature for a preceding cycle.

In said embodiments, preferably, the maximum product temperature during at least one of the one or more cycles is higher than the maximum product temperature during a preceding cycle.

In preferred embodiments, the heating phase temperature of at least one of the one or more cycles is lower than the heating phase temperature for a preceding cycle.

In said preferred embodiments, preferably, the maximum product temperature during a heating phase of at least one of the one or more cycles is lower than the maximum product temperature during a preceding cycle.

In some preferred embodiments, the heating phase temperature for at least one of the one or more cycles is between 1° C. and 20° C. lower than the heating phase temperature for a preceding cycle; including about 2° C. lower, about 3° C. lower, about 4° C. lower, about 5° C. lower, about 6° C. lower, about 7° C. lower, about 8° C. lower, about 9° C. lower, about 10° C. lower, about 11° C. lower, about 12° C. lower, about 13° C. lower, about 14° C. lower, about 15° C. lower, about 16° C. lower, about 17° C. lower, about 18° C. lower, and about 19° C. lower.

In said preferred embodiments, preferably, the maximum product temperature during at least one of the one or more cycles is between 1° C. and 20° C. lower than the maximum product temperature during a preceding cycle; including about 2° C. lower, about 3° C. lower, about 4° C. lower, about 5° C. lower, about 6° C. lower, about 7° C. lower, about 8° C. lower, about 9° C. lower, about 10° C. lower, about 11° C. lower, about 12° C. lower, about 13° C. lower, about 14° C. lower, about 15° C. lower, about 16° C. lower, about 17° C. lower, about 18° C. lower, and about 19° C. lower.

In other preferred embodiments, the heating phase temperature for at least one of the one or more cycles is between about 5° C. and about 15° C. lower than the heating phase for a preceding cycle; including about 6° C. lower, about 7° C. lower, about 8° C. lower, about 9° C. lower, about 10° C. lower, about 11° C. lower, about 12° C. lower, about 13° C. lower, and about 14° C. lower.

In said other preferred embodiments, preferably, the maximum product temperature during at least one of the one or more cycles is between about 5° C. and about 15° C. lower than the heating phase during a preceding cycle; including about 6° C. lower, about 7° C. lower, about 8° C. lower, about 9° C. lower, about 10° C. lower, about 11° C. lower, about 12° C. lower, about 13° C. lower, and about 14° C. lower.

In other preferred embodiments, the heating phase temperature for at least one of the one or more cycles is about 10° C. lower than the heating phase temperature for a preceding cycle.

In said other preferred embodiments, preferably, the maximum product temperature during at least one of the one or more cycles is about 10° C. lower than the heating phase temperature during a preceding cycle.

In preferred embodiments, the cooling phase temperature of each of the one or more cycles is between about 10° C. and about 80° C.; including about 15° C., about 20° C., about 25° C., about 30° C., about 35° C., about 40° C., about 45° C., about 50° C., about 55° C., about 60° C., about 65° C., about 70° C., and about 75° C.

In said preferred embodiments, preferably, the minimum product temperature during each of the one or more cycles is between about 10° C. and about 80° C.; including about 15° C., about 20° C., about 25° C., about 30° C., about 35° C., about 40° C., about 45° C., about 50° C., about 55° C., about 60° C., about 65° C., about 70° C., and about 75° C.

In other preferred embodiments, the cooling phase temperature of each of the one or more cycles is between about 15° C. and about 70° C.; including about 20° C., about 25° C., about 30° C., about 35° C., about 40° C., about 45° C., about 50° C., about 55° C., about 60° C., and about 65° C.

In said other preferred embodiments, preferably, the minimum product temperature during each of the one or more cycles is between about 15° C. and about 70° C.; including about 20° C., about 25° C., about 30° C., about 35° C., about 40° C., about 45° C., about 50° C., about 55° C., about 60° C., and about 65° C.

In other preferred embodiments, the cooling phase temperature of each of the one or more cycles is between about 20° C. and about 60° C.; including about 25° C., about 30° C., about 35° C., about 40° C., about 45° C., about 50° C., and about 55° C.

In said other preferred embodiments, preferably, the minimum product temperature during each of the one or more cycles is between about 20° C. and about 60° C.; including about 25° C., about 30° C., about 35° C., about 40° C., about 45° C., about 50° C., and about 55° C.

In preferred embodiments, the cooling phase temperature of a final cycle of said one or more cycles is about 25° C.

In said preferred embodiments, preferably, the minimum product temperature during a final cycle of said one or more cycles is about 25° C.

In preferred embodiments the duration of the heating phase of each of the one or more cycles is between about 2 minutes and about 30 minutes; including about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 21 minutes, about 22 minutes, about 23 minutes, about 24 minutes, about 25 minutes, about 26 minutes, about 27 minutes, about 28 minutes, and about 29 minutes. Preferably, the duration of the heating phase of each of the one or more cycles is about 5.5 minutes.

In preferred embodiments the duration of the cooling phase of each of the one or more cycles is between about 2 minutes and about 30 minutes; including about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 21 minutes, about 22 minutes, about 23 minutes, about 24 minutes, about 25 minutes, about 26 minutes, about 27 minutes, about 28 minutes, and about 29 minutes. Preferably, the duration of the cooling phase of each of the one or more cycle is about 5.5 minutes.

Applying a vacuum during the temperature treatment of the one or more cycles of the process described herein can increase the efficiency of removal of volatile substances contained within a particulate leguminous plant material.

In preferred embodiments, a vacuum is applied to a particulate leguminous plant material during at least one of the one or more cycles. Preferably, a vacuum is applied during a cooling phase of at least one of the one or more cycles. Preferably, a vacuum applied is in the range of 100-0.1 Kpa. Preferably a particulate leguminous plant material is gently agitated during vacuum treatment.

It will be appreciated that the particle size of a particulate leguminous plant material is a factor for the process herein described. It will be further appreciated that the particle size of a particulate leguminous plant material is a factor for the use of said material for animal consumption.

According to preferred embodiments, a particulate leguminous plant material may be ground or re-ground in order to achieve a desirable particle size distribution. Said grinding may be performed prior to and/or after subjecting said particulate plant material to cycles of temperature treatment as herein described. It will be appreciated that a combination of grinding and sieving steps may also be used to achieve a desired overall particle size while minimising the amount of out of specification product and therefore maximising yield and minimising waste. In light of the foregoing, it will also be appreciated that grinding, sieving and/or sifting steps can be performed on a conventional mill apparatus.

In preferred embodiments, at least 90% of a particulate leguminous plant material to be subjected to one or more cycles of temperature treatment as herein described has a particle size within a specific size range; including at least 91%, at least 92%, at least 93%, at least 94%, at least 95%, at least 96%, at least 97%, at least 98%, and at least 99%.

Preferably, said particle size is between about 100 μM and about 3000 μM in diameter; including about 200 μM, 300 μM, 400 μM, 500 μM, 600 μM, 700 μM, 800 μM, 900 μM, 1000 μM, 1100 μM, 1200 μM, 1300 μM, 1400 μM, 1500 μM, 1600 μM, 1700 μM, 1800 μM, 1900 μM, 2000 μM, 2100 μM, 2200 μM, 2300 μM, 2400 μM, 2500 μM, 2600 μM, 2700 μM, 2800 μM, and 2900 μM.

More preferably, said particle size is between about 500 and about 2500 μM in diameter; including about 600 μM, 700 μM, 800 μM, 900 μM, 1000 μM, 1100 μM, 1200 μM, 1300 μM, 1400 μM, 1500 μM, 1600 μM, 1700 μM, 1800 μM, 1900 μM, 2000 μM, 2100 μM, 2200 μM, 2300 μM, and about 2400 μM.

Even more preferably, said particle size is between about 1000 and about 2000 μM in diameter; including about 1100 μM, 1200 μM, 1300 μM, 1400 μM, 1500 μM, 1600 μM, 1700 μM, 1800 μM, and about 1900 μM.

In preferred embodiments, prior to use for animal consumption, a particulate leguminous material processed as herein described is re-ground such that at least 99% of the processed leguminous material has particle size equal to or less than about 400 μM; including about 375 μM, about 350 μM, about 325 μM, about 300 μM, about 275 μM, about 250 μM, about 175 μM, about 150 μM, about 125 μM, about 100 μM, about 75 μM, about 50 μM, about 25 μM.

More preferably, prior to use for animal consumption, a particulate leguminous material processed as herein described is re-ground such that at least 99% of the processed leguminous material has particle size equal to or less than about 200 μM; including about 190 μM, about 180 μM, about 170 μM, about 160 μM, about 150 μM, about 140 μM, about 130 μM, about 120 μM, about 110 μM, about 100 μM, about 90 μM, about 80 μM, about 70 μM, about 60 μM, about 50 μM, about 40 μM, about 30 μM, about 20 μM, and about 10 μM.

As will be appreciated by those skilled in the art, the moisture level of a particulate plant material before and after processing is a factor for the process described herein.

Preferably, the moisture level of a particulate leguminous plant material before processing is between about 5% and about 25%; including about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, and about 24%.

More preferably, the moisture level of a particulate leguminous plant material before processing is between about 10% and about 20%; including about 11%, about 12%, about 13%, about 14%, about 15%, about 16%, about 17%, about 18%, and about 19%.

After processing, preferably the moisture content of a particulate leguminous plant material is equal to or less than about 5%; including about 4%, about 3%, about 2%, and about 1%; and more preferably less than 3%, including about 2%, and about 1%.

In certain preferred embodiments, a leguminous plant material to be processed as described herein is dehulled. It will be appreciated that in those embodiments which contemplate dehulled leguminous plant material, the dehulling of a leguminous plant material may not be complete and therefore a small amount of hull may be left on a processed particulate leguminous plant material, and may be removed during later stages of processing. Preferably the hull comprises no greater than 5% w/w of the content of a particulate leguminous plant material processed as herein described, and more preferably less than 1% w/w.

The de-hulling of a leguminous plant material to be processed can be carried out using a decortication machine or an alternative abrasive process such as a rice pearler, similar to that used for de-hulling and polishing rice. The de-hulling process can be either a continuous or a batch process.

In general embodiments, a leguminous plant material to be processed may be conditioned by exposing said material to moisture, preferably for a period of between 12 and 24 hours. It will be appreciated that conditioning may assist the process of dehulling by loosening the hulls of a leguminous plant material in order to make de-hulling easier and reduce losses of the leguminous plant material.

In certain preferred embodiments, a leguminous plant material to be processed comprises seed that has germinated. Inclusion of a germination step prior to processing may increase the content of substances, such as vitamins, that are desirable for animal consumption.

Germination is a complex process that results in a number of significant biochemical changes in a seed. Generally, the conditions that support germination are adequate moisture, warm temperatures, and usually little or no light. Most seeds germinate best in the dark, although some require light. Germination can be induced by exposure of a leguminous seed to moisture under controlled conditions. Preferably, germination is performed under light-deprived conditions at room temperature.

The duration of germination can vary. Preferably, germination is performed for between 12 to 48 hours. More preferably, germination is allowed to proceed for about 24 hours.

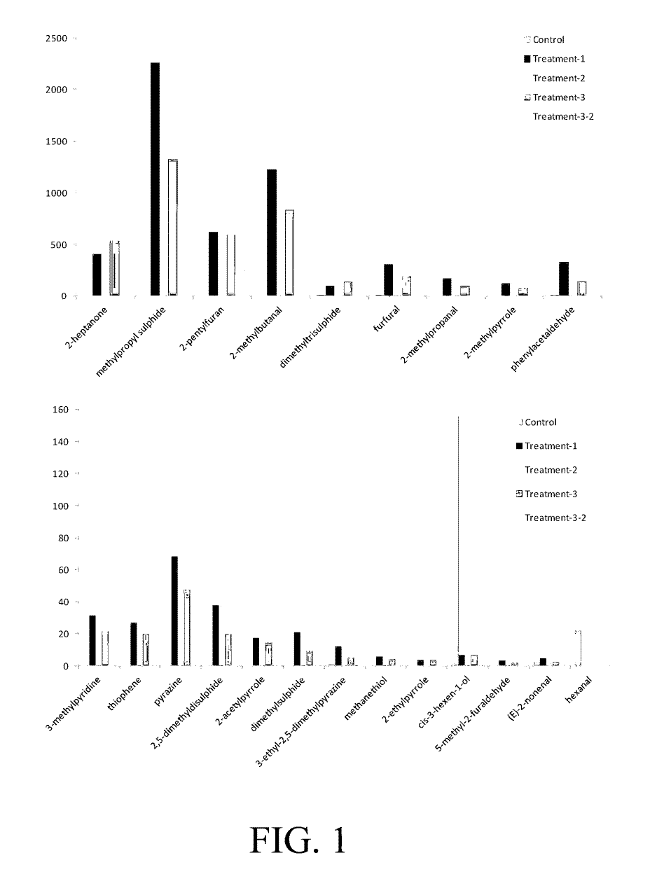

It will be appreciated that the equipment used to subject a particulate leguminous plant material to the cycles of temperature treatment for the process described herein is a consideration for this invention. In preferred embodiments the temperature treatment is conducted using a ‘fluidising bed’, similar to that described in International Publication Number WO 2010/063057, and FIG. 1 therein.

Preferably, a particulate leguminous plant material is suspended in a continuous fluid stream, and more preferably a fluidising stream.

Preferably, the fluid stream is a liquid or a gas.

More preferably, the fluid stream is a gas.

Even more preferably, the gas is air.

In the context of the present invention, by “suspended in a continuous fluid stream” is meant that a particulate leguminous plant material is distributed, mixed, dispersed, floated or otherwise maintained in a fluid stream or field so that the fluid-particulate mixture behaves or exhibits fluid-like properties. For example, this may be achieved by the introduction of pressurised fluid through a particulate medium at a rate or velocity sufficient to support the weight of the particles in a fluidised state. Moreover, the application of heating or cooling particulate matter which is suspended in a fluid stream results in the fluidisation of particles with a significant and rapid heat capacity and transfer whilst maintaining a homogenous or uniform temperature field. It will be appreciated that temperature transfer under such conditions results in consistent and controlled temperature treatment of the particles, thereby eliminating or minimising burnt particles and uneven temperature treatment.

The processing of a particulate leguminous plant material as herein described can be performed in a batch or a continuous system.

In preferred embodiments, the particulate leguminous plant material processed as herein described is a pulse legume. More preferably the pulse legume is selected from the following group: a mung bean, a chickpea, a field pea, an albus lupin, a navy bean, vetch, a lentil, an Australian sweet lupin, an adzuki bean, black gram, and a faba bean.

Still more preferably, the particulate leguminous plant material processed as herein described is a mung bean, a chickpea or a faba bean.

Preferably, when assessed orthonasally by one skilled in the art, a particulate leguminous plant material processed as herein described possesses significantly or substantially reduced aroma and/or flavour described as ‘green’, ‘beany’, ‘grassy’, ‘earthy’, ‘dusty’, or similar, as compared to a corresponding leguminous plant material that is unprocessed or processed using existing methods.

It will be recognised by one skilled in the art that the molecules hexanal, 3-hexen-1-ol, and 1-hexanol possess a potent ‘green’ or ‘grassy’ aroma, and can contribute to the ‘beany’, ‘green’ or ‘grassy’ aroma and flavour of leguminous plant material. Minimizing the concentration or amount of these and/or other compounds that normally contribute to odour and/or flavour comprised by an unprocessed particulate leguminous plant material can assist in producing a ‘mild’ or ‘neutral’ aroma of a processed particulate leguminous plant material.

Preferably, a particulate leguminous plant material processed as herein described comprises significantly or substantially reduced concentrations or amounts of one or more molecules that normally contribute to odour and/or flavour, as compared to a corresponding leguminous plant material that is unprocessed or processed using one or more other methods.

In some embodiments, said one or more molecules are, or include, alcohols, alkanals, and alkenes (e.g. C₆ compounds), although without limitation thereto. In some embodiments, said one or more molecules are selected from the group comprising 2-heptanone, 2-pentylfuran, 2-methylbutanal, 3-methylpyrrole, 2-methylpyrrole, furfural, 1-penten-3one, 1-hexanol, thiophene, 2,3-dimethylpyrrole, 2-methylpropanal, 2,3-pentandione, 2,5-dimethylphenol, benzaldehyde, dimethyl disulphide, ethylpyrazine, trimethylpyrazine, phenylacetaldehyde, 3-methylthiophene, 2-acetylfuran, 2-ethylpyrrole, ethyl 2,3-dimethylpyrazine, 2-ethyl-4-methylpyrrole, 2-acetylpyrrole, 2-ethyl-6-methylpyrazine, dimethyltrisulphide, furanmethanol, and 2-acetyl-1-pyrroline.

In particular embodiments, said one or more molecules are selected from the group consisting of hexanal, 3-hexen-1-ol, and 1-hexanol.

It will be recognised by one skilled in the art that subjecting a plant material to heating can result in the production of volatile compounds that can contribute to odour and/or flavour. Minimizing the concentration or amount of certain compounds that normally contribute to odour and/or flavour comprised by a particulate leguminous plant material subjected to heating can assist in producing a ‘mild’ or ‘neutral’ aroma and/or flavour of a processed particulate leguminous plant material.

Preferably, a particulate leguminous plant material processed as herein described comprises significantly or substantially reduced concentrations or amounts of one or more molecules that normally contribute to odour and/or flavour, as compared to a corresponding plant material that is processed using one or more other methods.

In some embodiments, said one or more molecules are, or include, alkanones, pyridines, furans and sulphides, although without limitation thereto. In particular embodiments, said one or more molecules are selected from the group comprising methyl pyridine, thiophene, 2-heptanone, 2-pentylfuran, dimethyltrisulphide, methyl propyl sulphide, 2-methyl butanal, 2,5-dimethyldisulphide and pyrazine.

It will be recognised that certain vitamin compounds are highly desirable for animal consumption.

Preferably, a leguminous plant material processed as herein described comprises similar or higher amounts or concentrations of one or more vitamin compounds as compared to a corresponding leguminous plant material that is unprocessed or processed using one or more other methods. In particular embodiments, the one or more vitamin compounds are B group vitamins and/or Vitamin C. In particular embodiments the one or more vitamin compounds are selected from the group comprising pantothenic acid (Vitamin B5), ascorbate (Vitamin C), thiamin (Vitamin B1), riboflavin (Vitamin B2), niacin (Vitamin B3), pyridoxine (Vitamin B6), and folate (Vitamin B9).

Preferably, a particulate leguminous plant material processed as herein described comprises an amount or concentration of pantothenic acid (Vitamin B5) that is higher or increased as compared to a corresponding leguminous material that is unprocessed or processed using one or more other methods.

It will be readily appreciated that a particulate leguminous plant material processed as described by this invention can be desirable for animal consumption. It will be further recognised that said particulate leguminous plant material may have desirable characteristics as compared to a corresponding leguminous plant material that is unprocessed or processed using one or more other methods, for direct animal consumption, or for incorporation into a food product.

Desirable characteristics of a particulate leguminous plant material processed as described by this invention for direct use as a food, and/or for incorporation into a food product, may include an odour and/or flavour that is ‘neutral’ or ‘mild’. For example, although without limitation thereto, said processed particulate leguminous plant material may possess decreased strength or intensity of aroma and/or flavour described as ‘green’, ‘beany’, ‘grassy’, ‘earthy’, ‘dusty’, or similar, and/or possess decreased strength or intensity of aroma and/or flavour described as ‘burnt’, ‘roasted’, ‘nutty’, ‘coffee’, ‘bitter’, ‘meaty’ or similar, as compared to a corresponding leguminous plant material that is unprocessed or processed using one or more other methods.

Desirable characteristics of a processed leguminous plant material as herein described may also include a concentration of one or more substances that are desirable for animal consumption, for example pantothenic acid (vitamin B5) or folate (vitamin B9), that is similar or higher as compared to a corresponding leguminous plant material that is unprocessed or processed using one or more other methods.

The processed leguminous material may itself be used directly (i.e. ‘straight’ or ‘neat’) as a food, or may used in a food product. In embodiments wherein the processed leguminous material is used in a food product, said food product may be selected from, but is not limited to, the following group: a grain-based food product, a dairy based food product, a cereal, a baked product, a health bar, a nutrition bar, a snack bar, a liquid food product, a semi-liquid food product, a fruit juice, a vegetable juice, a sauce, a flour, a seasoning, and a spreadable food product.

So that the invention may be readily understood and put into effect, the following non-limiting examples are provided.

### EXAMPLES

The following examples set forth preferred embodiments of the process described by the present invention for producing a particulate leguminous plant material with desirable characteristics for animal consumption. The examples further demonstrate assessment of some important characteristics of said processed particulate leguminous plant material as compared to a corresponding leguminous material that is unprocessed.

### Example 1: Mung Bean

This example describes preparation and analysis of a control mung bean sample (Control) and four mung bean samples processed according to embodiments of the invention (Treatment-1; Treatment-2; Treatment-3; and Treatment-3-2).

### Material and Methods

### Dehulling of Plant Material

Mung bean was soaked in water for approximately 18 hours. A decortication machine was used to dehull the material such that less than 1% of the material by weight consisted of hull material.

### Plant Material

Dehulled mung bean with the following composition was used:
Protein content: 25%
Carbohydrate: 57%
Fat: 1.1%
Crude fibre: 0.6%
Ash: 3.5%

The starting moisture of mung bean for processing was adjusted to 15%.

The mung bean was ground and sieved, such that 90% of the mung bean material possessed particle size between 1000 and 1500 μM, as assessed using a vibratory sieving test.

### Grinding of Plant Material

A conventional flour mill apparatus was used to perform all grinding and sieving of mung bean material to obtain desired particle size for processing.

### Fluidising Bed

A fluidising bed with characteristics as described in WO 2010/063057 and FIG. 1 therein, hereinbefore cited, was used to subject the particulate mung bean material to temperature treatment. The air velocity for the fluidising bed was 3 m/s.

### Temperature Treatment

Conditions of temperature treatment tested were as follows.

### Control:

No temperature treatment.

### Treatment-1:

Number of temperature treatment cycles: 1
Temperature of heating phase: 188° C.
Duration of heating phase: 5.5 min
Temperature of cooling phase: 25° C.
Duration of cooling phase: 15.5 min

### Treatment-2:

Number of temperature treatment cycles: 1
Temperature of heating phase: 180° C.
Duration of heating phase: 5.5 min
Temperature of cooling phase: 25° C.
Duration of cooling phase: 15.0 min

### Treatment-3:

Number of temperature treatment cycles: 2
Temperature of heating phase for first cycle: 178° C.
Duration of heating phase for first cycle: 5.5 min
Temperature of cooling phase for first cycle: 60° C.
Duration of cooling phase for first cycle: 15.0 min
Temperature of heating phase for the second cycle 170
Duration of heating phase for second cycle 4.5 min
Temperature of cooling phase for the second cycle: 25° C.
Duration of cooling phase for the second cycle 15.0 min

### Treatment-3-2:

Number of temperature treatment cycles: 3
Temperature of heating phase for first cycle: 178° C.
Duration of heating phase for first cycle: 5.5 min
Temperature of cooling phase for first cycle: 60° C.
Duration of cooling phase for first cycle: 15.0 min
Temperature of heating phase for second cycle: 170° C.
Duration of heating phase for second cycle: 5.5 min
Temperature of cooling phase for second cycle: 60° C.
Duration of cooling phase for second cycle: 15.0 min
Temperature of heating phase for third cycle: 160° C.
Duration of heating phase for third cycle: 5.5 min
Temperature of cooling phase for third cycle: 25° C.
Duration of cooling phase for third cycle: 15.0 min

### Vacuum Treatment

Optionally, a vacuum of approximately 3 Kpa can be applied to the plant material during the cooling phase of one or more of the temperature treatment cycles, in conjunction with gentle agitation of the plant material.

### Initial Sensory Analysis

All samples were ‘sniffed’ orthonasally by a team of assessors led by an experienced flavour chemist, and sensory aroma notes were made.

### Dynamic Headspace Aroma Extraction and Olfactometry

For all samples, 20 g particulate leguminous plant material was weighed into a 500 mL Schott bottle and 40 mL of Milli-Q water was added together with 50 μL of an internal standard (4-methylpentanol). The sample bottle was sealed with a gas-tight Teflon closure fitted with custom made connecting gas ports. The headspace was purged with high purity nitrogen (120 mL/min) for 40 minutes and volatiles were collected onto Tenax-GR traps (60/80 mesh size, 100 mg). The traps were desorbed using a short path thermal desorption unit (Scientific Instrument Services, New Jersey, USA) directly into the hot GC injector (250° C.). A GC-MS (Varian 4000 ion-trap) and an olfactory port (ODO-II, SGE, Australia) were connected to the GC capillary column via a splitting device; the column effluent was split approximately 1:1 to the MS detector and the ‘sniff-port’. The intensity of the odour detected at the sniff-port was measured using time intensity software ‘SensoMaker’; sensory data were acquired at 1 Hz. Volatile separation was achieved using a Zebron-WAX column (Phenomenex, 60 m, 0.32 i.d., 0.5 m film) with the following temperature programming; initial temperature 40° C. (held for 5 minutes) then increased at 6° C./min to 245° C. (held for 0 minutes) and finally 30° C./min at 260° C. (held for 1 minute). The transfer line to the MS was held at 260° C. and the ion-trap detector was operated at 200° C., the emission current set at 10 μAmps for electron impact (EI) mass spectra. A search library for compounds of interest was used to integrate peak areas in total ion chromatograms. Peaks were identified on the basis of mass spectral matches in the National Institute of Standards and Technology (NIST) of the United States of America mass spectral database, retention times and odour quality. The volatiles of selected samples were also concentrated by solid phase microextraction and analysed using a single quadrupole GC-MS (Shimadzu-2010 GC-MS), WAX capillary column. This was used to assist in identification of volatiles in some cases.

### Results

### Initial Sensory Analysis

Table 1 sets forth results of initial sensory analysis of unprocessed samples, and samples treated using the four processing variations: Treatment-1, Treatment-2, Treatment-3, and Treatment-3-2. The aroma of the unprocessed sample (Control) was described as ‘green’, ‘beany’, ‘earthy’, and ‘dusty’. The aroma of samples processed according to Treatment-1 and Treatment-2 was described as ‘strong’, and/or ‘burnt’, ‘intense’, ‘coffee’, and ‘savoury’. The aroma of samples processed according to Treatment-3 and Treatment-3-2 was described as ‘mild’ and ‘peanut butter’.

TABLE 1

| Sample | Sensory descriptors |
|---|---|
| Control | Mild, tortilla, green, beany, corn, earthy, dusty |
| Treatment-1 | Strong roasted nuts, savoury, roasted peanut butter |
| Treatment-2 | Strong, intense, roasted nuts, burnt note, coffee, |
| | underlying sweet and buttery notes, dairy |
| Treatment-3 | Mild roasted corn, peanut butter, buttery |
| Treatment-3-2 | Milder, roast grains, peanut butter |

### Dynamic Headspace Aroma Extraction and Olfactometry

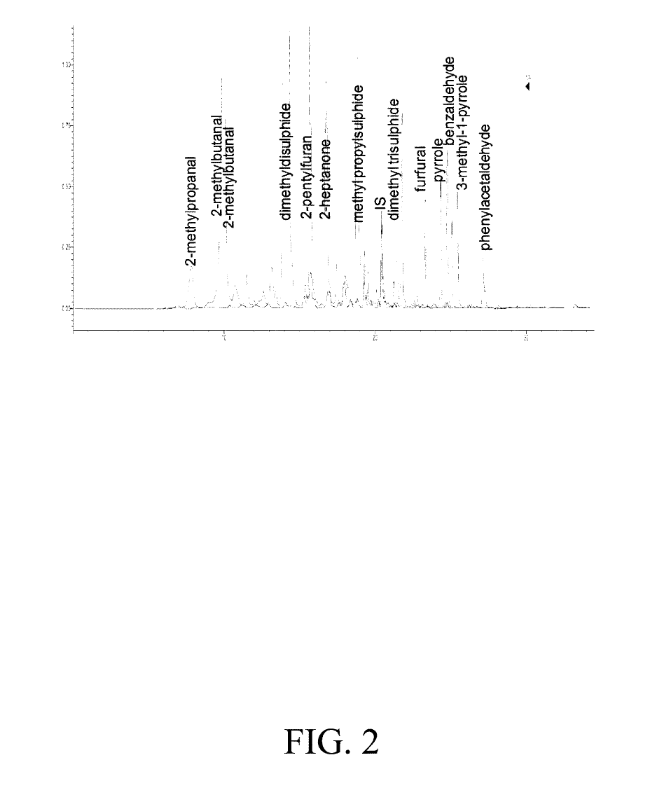

FIG. 1 sets forth semi-quantitative gas chromatography olfactometry (GC-O) data obtained from an unprocessed sample (Control), and samples treated using four processing variations: Treatment-1, Treatment-2, Treatment-3, and Treatment-3-2. Levels of cis-3-hexen-1-ol and hexanal were dramatically reduced or absent in processed samples as compared to the unprocessed control sample. A range of volatile compounds were present at detectable levels in the processed samples but undetectable in the unprocessed control, e.g. FIG. 2. The levels of many volatiles, including methyl propyl sulphide, 2,5-dimethyldisulphide, and pyrazine, decreased as the number of temperature treatment cycles used in a processing treatment increased, i.e. concentration in Treatment-1>concentration in Treatment-2>concentration in Treatment 3>concentration in Treatment 3-2.

### Assessment of Vitamin Levels

Table 2 sets forth the level of selected B group vitamins in an unprocessed sample (Control) and a sample processed according to Treatment-3-2. The level of Vitamin B5 (pantothenic acid) was substantially elevated in the sample processed according to Treatment 3-2, as compared to the control sample. The levels of Vitamin B1 and Vitamin B9 were similar in the Treatment-3-2 processed sample as compared to the control sample.

TABLE 2

| Vitamin | Control (mg/100 g) | Treatment-3-2 (mg/100 g) |
|---|---|---|
| B1 (thiamine) | 0.26 | 0.23 |
| B5 (pantothenic acid) | 5.80 | 6.90 |
| B9 (folic acid) | 0.06 | 0.06 |

### Example 2. Chickpea and Faba Bean

This example describes preparation and analysis of two control chickpea bean samples (C-01 and C-01 Ground) and two chickpea samples processed according to embodiments of the invention (C-02 and C-03); and two control faba bean samples (F-01 and F-01-Ground) and two faba bean samples processed according to embodiments of the invention (F-02 and F-03).

### Dehulling of Plant Material

Chickpea or faba bean material was soaked in water for approximately 18 hours. A decortication machine was used to dehull the material such that less than 1% of the material by weight consisted of hull material.

### Plant Material

The starting moisture of the material for processing was adjusted to 15%.

Sample C-01 was raw chickpea kibble. Sample F-01 was raw faba bean kibble.

For all other samples the plant material (chickpea or faba bean) was ground and sieved such that 90% of the material possessed particle size between 1000 and 1500 μM, as assessed using a vibratory sieving test.

### Fluidising Bed

A fluidising bed with characteristics as described in WO 2010/063057 and FIG. 1 therein, hereinbefore cited, was used to subject the particulate material to temperature treatment. The air velocity for the fluidising bed was 3 m/s.

### Temperature Treatment

Conditions of temperature treatment tested were as follows.

### Control Samples (C-01, C-01 Ground, F-01, F-01-Ground):

No temperature treatment.

### C-02 and F-02:

Number of temperature treatment cycles: 1
Temperature of heating phase: 180° C.
Duration of heating phase: 5.5 min
Temperature of cooling phase: 25° C.
Duration of cooling phase: 15.0 min

### C-03 and F-03:

Number of temperature treatment cycles: 3
Temperature of heating phase for first cycle: 178° C.
Duration of heating phase for first cycle: 5.5 min
Temperature of cooling phase for first cycle: 60° C.
Duration of cooling phase for first cycle: 15.0 min
Temperature of heating phase for second cycle: 170° C.
Duration of heating phase for second cycle: 5.5 min
Temperature of cooling phase for second cycle: 60° C.
Duration of cooling phase for second cycle: 15.0 min
Temperature of heating phase for third cycle: 160° C.
Duration of heating phase for third cycle: 5.5 min
Temperature of cooling phase for third cycle: 25° C.
Duration of cooling phase for third cycle: 15.0 min

### Dynamic Headspace Aroma Extraction and Olfactometry

For all samples, 20 g particulate leguminous plant material was weighed into a 500 mL Schott bottle and 40 mL of Milli-Q water was added together with 50 L of an internal standard (4-methylpentanol). The sample bottle was sealed with a gas-tight Teflon closure fitted with custom made connecting gas ports. The headspace was purged with high purity nitrogen (120 mL/min) for 40 minutes and volatiles were collected onto Tenax-GR traps (60/80 mesh size, 100 mg). The traps were desorbed using a short path thermal desorption unit (Scientific Instrument Services, New Jersey, USA) directly into the hot GC injector (250° C.). A GC-MS (Varian 4000 ion-trap) and an olfactory port (ODO-II, SGE, Australia) were connected to the GC capillary column via a splitting device; the column effluent was split approximately 1:1 to the MS detector and the ‘sniff-port’. The intensity of the odour detected at the sniff-port was measured using time intensity software ‘SensoMaker’; sensory data were acquired at 1 Hz. Volatile separation was achieved using a Zebron-WAX column (Phenomenex, 60 m, 0.32 i.d., 0.5 m film) with the following temperature programming; initial temperature 40° C. (held for 5 minutes) then increased at 6° C./min to 245° C. (held for 0 minutes) and finally 30° C./min at 260° C. (held for 1 minute). The transfer line to the MS was held at 260° C. and the ion-trap detector was operated at 200° C., the emission current set at 10 μAmps for electron impact (EI) mass spectra. A search library for compounds of interest was used to integrate peak areas in total ion chromatograms. Peaks were identified on the basis of mass spectral matches in the National Institute of Standards and Technology (NIST) of the United States of America mass spectral database, retention times and odour quality. The volatiles of selected samples were also concentrated by solid phase microextraction and analysed using a single quadrupole GC-MS (Shimadzu-2010 GC-MS), WAX capillary column. This was used to assist in identification of volatiles in some cases.

### Results

### Dynamic Headspace Aroma Extraction and Olfactometry

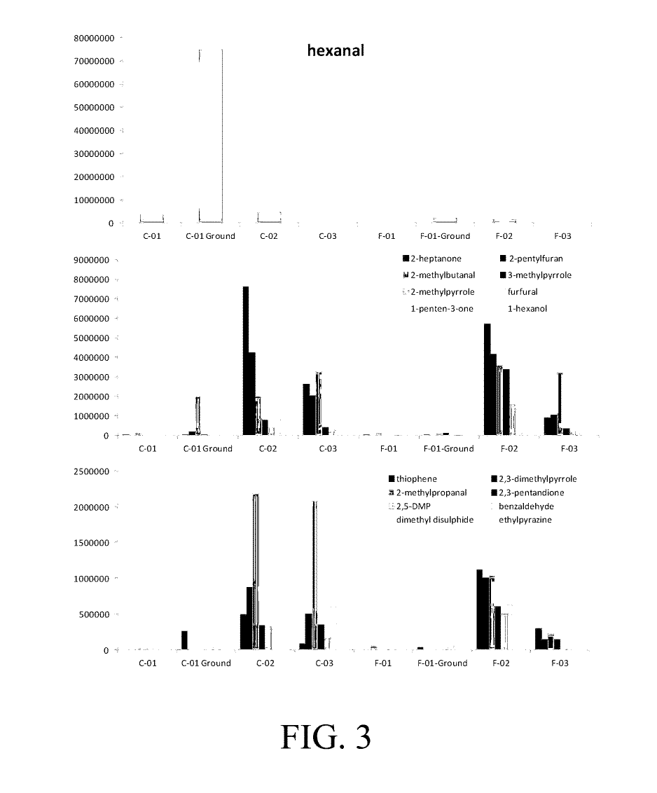

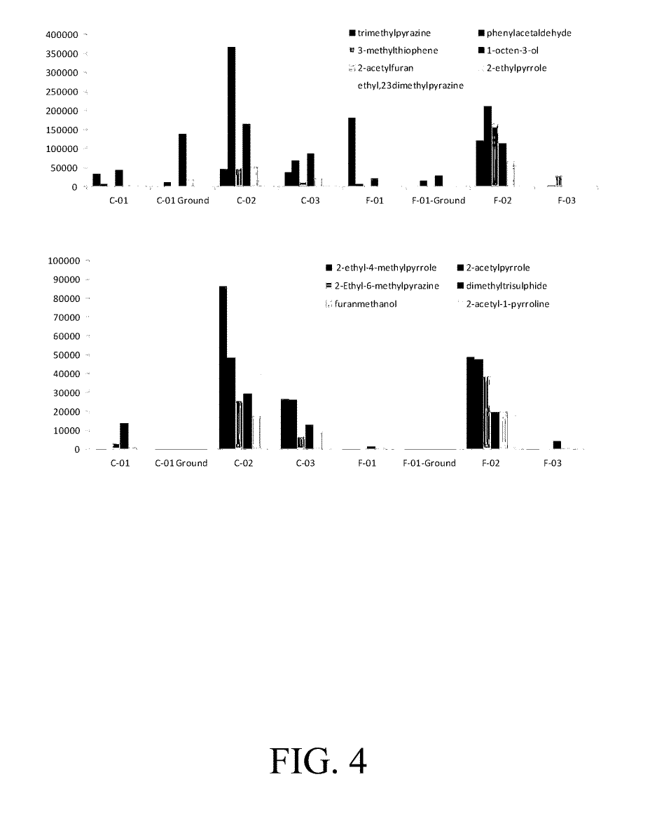

FIGS. 3 and 4 set forth semi-quantitative gas chromatography olfactometry (GC-O) data obtained from unprocessed samples of chickpea and faba bean kibble (C-01 and F-01, respectively); unprocessed samples of ground chickpea and faba bean (C-01 Ground and F-01-Ground, respectively); and ground chickpea and faba bean samples treated using a first processing variation of the invention (C-02 and F-02, respectively) and a second processing variation of the invention (C-03 and F-03, respectively).

It will be readily appreciated that comparison of the data obtained for the ground control samples (C-01 Ground and F-01-Ground), and the corresponding samples processed according to embodiments of the process of the invention, provides the clearest demonstration of the effect of processing on the levels of the detected compounds in the samples.

Levels of hexanal were reduced or absent in the ground chickpea samples processed according to the invention (C-02 and C-03) as compared to the unprocessed ground chickpea control sample (C-01 Ground). Similarly, levels of hexanal were reduced or absent in the ground faba bean samples processed according to the invention (F-02 and F-03) as compared to the unprocessed ground chickpea control sample (F-01-Ground).

The levels of many volatiles, including 2-heptanone, 2-pentylfuran, 3-methylpyrrole, phenylacetaldehyde, 2,5-dimethyldisulphide, 1-octen-3-ol, and furanmethanol, were substantially decreased in the chickpea and faba bean samples processed according to an embodiment of process of the invention comprising 3 temperature treatment cycles (C-03 and F-03, respectively), as compared to the respective samples processed according to an embodiment of the process of the invention comprising a single temperature treatment cycle (C-02 and F-02, respectively).

### DISCUSSION

In the examples set forth above, particulate leguminous material was subjected to one or more cycles of temperature treatment, each cycle involving a ‘heating phase’ and a ‘cooling phase’. Sensory and biochemical analysis was then performed for the processed samples and corresponding unprocessed control samples.

As described in Example 1, as assessed by preliminary sensory analysis, the aroma of a control mung bean sample was described as ‘green’, ‘beany’, ‘earthy’, and ‘dusty’; such odours are commonly associated with mung bean and other legumes, particularly the ‘pulse’ or ‘grain’ legumes. In contrast, these odours were absent from the processed mung bean samples. Furthermore, as the number of temperature cycles increased, the odour of the processed mung bean samples became milder, as assessed by preliminary sensory analysis. Aroma of mung bean samples processed using one cycle of temperature treatment was described as ‘strong’ and/or ‘intense’. Two cycles of temperature treatment resulted in mung bean samples with aroma described as ‘mild roasted corn’, while mung bean samples subjected to three cycles of temperature treatment possessed aroma described as ‘milder’.

As set forth in Examples 1-3, the concentration of hexanal, known for its potent ‘grassy’ or ‘green’ odour, was reduced or absent in mung bean, chickpea, and faba bean samples processed according to embodiments of the invention, relative to respective control samples, as assessed by gas chromatography olfactometry (GC-O) (e.g., FIGS. 1 and 3)

GC-O also detected a range of volatile compounds in samples processed according the invention that were undetectable in the respective unprocessed control samples (e.g., FIGS. 1, 3, and 4). Consistent with the preliminary sensory analysis performed for mung bean samples as set forth in Example 1, concentrations of many known odour-active compounds (e.g. 2-pentylfuran, 2,5-dimethyldisulphide, furfural and pyrazine) were decreased in samples processed according to embodiments of the invention comprising a greater number of temperature treatment cycles, as compared to embodiments of the invention comprising a lesser number of temperature treatment cycles (e.g., FIGS. 1, 3, and 4).

Processing according to the invention as performed in the experiments set forth in the examples was highly effective in eliminating the ‘green’, ‘beany’ odour particulate mung bean as assessed by sensory analysis, and highly effective in reducing the concentration of hexanal, known to contribute to such odour, in particulate mung bean, particulate chickpea, and particulate faba bean material, as assessed by GC-O.

Furthermore, processing particulate leguminous plant material according to an embodiment of the invention comprising three cycles of temperature treatment minimized the concentration of volatile compounds produced during processing. As evidenced by sensory analysis of the particulate mung bean sample ‘Treatment-3-2’ set forth in Example 1, this resulted in a mild aroma of the particulate leguminous material.

Furthermore, as set forth in Example 1, the concentration of B group vitamins was found to be highly similar, or in the case of Vitamin B5, substantially increased, in a sample processed according to an embodiment of the invention comprising three cycles of temperature treatment.

Throughout the specification, the aim has been to describe the preferred embodiments of the invention without limiting the invention to any one embodiment or specific collection of features. Various changes and modifications may be made to the embodiments described and illustrated without departing from the present invention.

The disclosure of each patent and scientific document, computer program and algorithm referred to in this specification is incorporated by reference in its entirety.

1. A process for the production of a particulate leguminous plant material with desirable characteristics for animal consumption, as compared to a corresponding particulate leguminous plant material that is unprocessed or processed using one or more other methods, said process including subjecting a particulate leguminous plant material to two or more cycles of temperature treatment involving a heating phase and a cooling phase, wherein the heating phase temperature of at least one of the two or more temperature treatment cycles is lower than the heating phase temperature of the preceding temperature treatment cycle.

2. The process according to claim 1 wherein the total number of temperature treatment cycles is at least three, or at least four.

3. The process according to claim 1, wherein the heating phase temperature of each of the one or more temperature treatment cycles is between about 120° C. and about 190° C.

4. The process according to claim 3, wherein the particulate leguminous plant material reaches a maximum product temperature in each of the one or more temperature treatment cycles between about 120° C. and about 190° C.

5. The process according to claim 13, wherein the heating phase temperature for each of said one or more of the one or more temperature treatment cycles is between about 1° C. and about 20° C. lower, between about 5° C. and about 15° C. lower, or about 10° C. lower, than the heating phase temperature for the preceding temperature treatment cycle.

6. The process according to claim 5, wherein the particulate leguminous plant material reaches a maximum product temperature for each of said one or more of the one or more temperature treatment cycles between about 1° C. and about 20° C. lower, between about 5° C. and about 15° C. lower, or about 10° C. lower, than the maximum product temperature for the preceding temperature treatment cycle.

7. The process according to claim 1 wherein the cooling phase temperature of each of the one or more temperature treatment cycles is between about 10° C. and about 80° C., between about 15° C. and about 70° C., between about 20° C. and about 60° C., or about 25° C.

8. The process according to claim 7, wherein the particulate leguminous plant material reaches a minimum product temperature in each of the one or more temperature treatment cycles between about 10° C. and about 80° C., between about 15° C. and about 70° C., between about 20° C. and about 60° C., or about 25° C.

9. The process according to claim 1, wherein the particulate leguminous plant material has a mean particle size between about 100 and about 3000 μM in diameter, between about 250 and 2500 μM in diameter, between about 500 and about 2200 μM in diameter, or between about 1000 and about 2000 μM in diameter, prior to said process.

10. The process according to claim 1, wherein the moisture content of the particulate leguminous plant material is between about 5% and about 25%, or between about 10% and about 20%, prior to said process.

11. The process according to claim 1, wherein the moisture content of the particulate leguminous plant material is less than about 5% or less than about 3%, after said process.

12. The process according to claim 1, wherein a processed particulate leguminous plant material produced according to said process comprises substantially or significantly reduced concentrations of one or more molecules that contribute to odour.

13. The process according to claim 12, wherein the one or more molecules are, or include, alcohols, alkanals, alkenes, alkanones, pyridines, furans and sulphides, hexanal, 3-hexen-1-ol, 1-hexanol, methyl pyridine, thiophene, 2-heptanone, 2-pentylfuran, dimethyltrisulphide, 2-methyl butanal, methyl propyl sulphide, 2,5-dimethyldisulphide and pyrazine.

14. The process according to claim 1, wherein the particulate leguminous plant material produced according to said process possesses amounts or concentrations of one or more vitamin compounds that are similar or higher than a corresponding leguminous plant material that is unprocessed or processed using one or more other methods.

15. The process according to claim 1, wherein the particulate leguminous plant material is a mung bean, a chickpea or a fava bean.

16. (canceled)

17. A processed particulate leguminous material that comprises substantially or significantly reduced amounts or concentrations of one or more molecules that normally contribute to odour and/or flavour, and/or comprises a relatively increased amount or concentration of one or more vitamins.

18. The processed particulate leguminous material of claim 17, wherein the one or more molecules are, or include, alcohols, alkanals, alkenes, alkanones, pyridines, furans and sulphides, hexanal, 3-hexen-1-ol, 1-hexanol, methyl pyridine, thiophene, 2-heptanone, 2-pentylfuran, dimethyltrisulphide, methyl propyl sulphide, 2-methyl butanal, 2,5-dimethyldisulphide and pyrazine.

19. The processed particulate leguminous material of claim 17, wherein the one or more vitamins are selected from the group consisting of: pantothenic acid (Vitamin B5), ascorbate (Vitamin C), thiamine (Vitamin B1), riboflavin (Vitamin B2), niacin (Vitamin B3), pyridoxine (Vitamin B6), and folate (Vitamin B9).

20. The processed particulate leguminous material of claim 17, wherein the particulate leguminous plant material is a mung bean, a chickpea or a fava bean.

21. A food product comprising the particulate leguminous material according to claim 17.

22. (canceled)

23. The food product of claim 21 wherein the food product is selected from the group consisting of: a grain-based food product, a dairy based food product, a cereal, a baked product, a health bar, a nutrition bar, a snack bar, a liquid food product, a semi-liquid food product, a fruit juice, a vegetable juice, a sauce, a flour, a seasoning, and a spreadable food product.

24. (canceled)

25. A process of producing a food product comprising a particulate leguminous plant material with desirable characteristics for animal consumption, as compared to a corresponding particulate leguminous plant material that is unprocessed or processed using one or more other methods, said process including subjecting a particulate leguminous plant material to two or more cycles of temperature treatment involving a heating phase and a cooling phase, wherein the heating phase temperature of at least one of the two or more temperature treatment cycles is lower than the heating phase temperature of the preceding temperature treatment cycle.

26. The process of claim 24, wherein the food product is selected from the group consisting of: a grain-based food product, a dairy based food product, a cereal, a baked product, a health bar, a nutrition bar, a snack bar, a liquid food product, a semi-liquid food product, a fruit juice, a vegetable juice, a sauce, a flour, a seasoning, and a spreadable food product.
